(19) United States
(12) Patent Application Publication
(10) Pub. No.: US 2024/0286909 A1
(43) Pub. Date: Aug. 29, 2024

(54) PRODUCTION OF HEXACHLORODISILOXANE

(71) Applicant: Wonik Materials North America, LLC, Germantown, WI (US)

(72) Inventors: Venkateswara Rao Chitturi, Germantown, WI (US); Andrey Korolev, Shorewood, WI (US)

(21) Appl. No.: 18/391,295

(22) Filed: Dec. 20, 2023

Related U.S. Application Data
(60) Provisional application No. 63/486,900, filed on Feb. 24, 2023.

(51) Int. Cl. C01B 33/113

(52) U.S. Cl. CPC C01B 33/113

(57) ABSTRACT

A method for the synthesis of perchlorodisiloxanes, and particularly hexachlorodisiloxane (Si₂OCl₆, HCDSO), using an amount of tetrachlorosilane (SiCl₄) with an amount of molybdenum trioxide (MoO₃). The method, in its broadest form, can be used to synthesize perchlorosiloxanes of the general formulae SiₓOₓ₋₁Cl₂ₓ₊₂. A catalytic amount of anhydrous HCl may be used to speed the reaction.

### RELATED APPLICATION

The present application claims the filing priority of U.S. Provisional Application No. 63/486,900 titled “Production of Hexachlorodisiloxane” and filed on Feb. 24, 2023. The '900 application is hereby incorporated by reference.

### TECHNICAL FIELD OF THE INVENTION

The present disclosure is directed to the synthesis of hexachlorodisiloxane (Si₂OCl₆, HCDSO) and can be expanded to the synthesis of other perchlorosiloxanes of the general formulae SiₓOₓ₋₁Cl₂ₓ₊₂, such as octochlorotrisiloxane (OCTSO).

### BACKGROUND OF THE INVENTION

Hexachlorodisiloxane (HCDSO) is a chemical compound that found several applications including modified rubbers [See U.S. Pat. No. 7,335,706 B1 to Halasa et al., 2008], silicon oxide and modified surface coatings [See U.S. Pat. No. 7,749,920 B2 to Sakurai et al., 2010; and U.S. Pat. No. 5,851,726 to Ikuta et al., 1998], crosslinkable dielectrics [See U.S. Pat. No. 8,853,820 B2 to Kastler et al., 2014; and U.S. Pat. No. 8,907,337 B2 to Marks et al., 2014] and chemical vapor or atomic layer deposition of silicon oxide films [See U.S. Pat. No. 7,084,076 B2 to Park et al., 2006; U.S. Pat. No. 7,943,531 B2 to Nemani et al., 2011; U.S. Pat. No. 7,407,897 B2 to Won et al., 2008; and U.S. Pat. No. 7,498,273 B2 to Mallick et al., 2009]. Each of the cited U.S. Patents above is hereby incorporated by reference.

Apart from very obscure and impractical reactions where HCDSO is formed as a by-product or one of the products, there are two major methods of HCDSO production that are commonly used in chemical industry. A first method [See Schumb, Stevens J. Amer. Chem. Soc. 1947, vol. 69, p. 726; Schumb, Stevens J. Amer. Chem. Soc. 1950, vol. 72, p. 3178, hereby incorporated by reference] is represented by the following reaction scheme (Scheme 1):

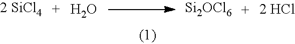

In this method, water is slowly added to a mixture of SiCl₄ and ether cooled to a very low temperature. The reaction usually completes in a few hours, and the product is isolated by fractional distillation of the resulting mixture. This method may be quite useful on a small to medium scale due to quick reaction time and use of inexpensive starting materials. On the other hand, this method requires the use of very low reaction temperatures (−70° C. or below), excess of silicon tetrachloride (SiCl₄) and significant amount of diethyl ether (Et₂O) that results in a big problem of handling and disposing off a huge waste stream of highly corrosive and flammable mixture of SiCl₄, Et₂O and HCl. The prohibitive cost of this waste disposal, coupled with a mediocre yield (˜30% based on water) of a target product (HCDSO) makes this method less attractive for a large volume production.

As shown below, a second method [See Grigor, Wilkins Inorganic Syntheses, 1963, vol. 7, p. 23, hereby incorporated by reference] (Scheme 2) involves passing of a mixture of SiCl₄ vapor and oxygen gas through a tube reactor heated to 900° C.:

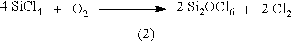

A single pass through the reactor gives a very small amount of product, so in order to achieve a substantial yield, the unreacted SiCl₄ is recirculated back into the process, and after multiple passes a mixture containing HCDSO and other perchlorosiloxanes is fractionally distilled to isolate HCDSO. Even though this method seems quite simple on the paper it does pose significant safety and reactor design problems: use of oxygen gas at extremely high temperatures, scrubbing highly reactive and toxic chlorine gas, designing the recirculating reactor capable of handling dangerous gases. Considering the long process times (days) and about the same mediocre yield (below 30%), this method also cannot be recommended for a large volume production.

In this disclosure, a new method of making HCDSO is described which avoids many pitfalls of the two schemes set forth above. Until the invention of the present application, these and other problems in the prior art went either unnoticed or unsolved by those skilled in the art. The present invention provides a method which provides high-purity HCDSO (99% or higher) in a reasonable time and with acceptable yield (over 30%).

### SUMMARY OF THE INVENTION

There is disclosed herein a new method for making perchlorodisiloxanes, specifically hexachlorodisiloxane (HCDSO) which avoids the disadvantages of prior methods while affording additional advantages.

Generally speaking, the method comprises of mixing an amount of tetrachlorosilane (SiCl₄) with an amount of molybdenum trioxide, MoO₃ within a reaction vessel.

In an embodiment of the method, tetrachlorosilane is taken either in stoichiometric amount or in excess to the amount of molybdenum trioxide according to the reaction:

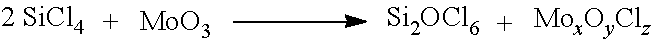

The Mo containing by-product in the above reaction represented as MoₓO_{y}Cl_{z} is not a unique compound but rather a complex mixture of molybdenum oxo-chlorides; identification of the components and nature of this mixture is beyond the scope of this patent.

The stoichiometric amount is typically considered 2 molar parts of tetrachlorosilane to 1 molar part of molybdenum trioxide, but in some specific cases could be comprised of 4:1 or 6:1 as SiCl₄: MoO₃ molar ratio. The excess amount of tetrachlorosilane is chosen arbitrary from just above 1 and up to 3 times the stoichiometric amount mentioned above. More specifically, excess of 2 times the stoichiometric amount of tetrachlorosilane mentioned above is preferred.

Preferably, the reaction mixture is stirred under inert atmosphere at ambient temperature for a period of time.

Preferably, inert atmosphere in the reaction vessel is provided by the use of inert gas such as nitrogen (N2) argon (Ar) or helium (He).

Preferably, ambient temperature is selected from the range of 10-40° C. and the reaction time falls within the range of 24-72 hours.

In specific embodiments a catalytic amount of anhydrous hydrogen chloride (HCl) is added to the reaction mixture to facilitate (speed up) the reaction. The HCl can be added as an anhydrous HCl solution in diethyl ether or as anhydrous HCl gas. Further, the amount of HCl is chosen from the range of 3-15 molar percent based on the molar amount of molybdenum trioxide used in the process.

In specific embodiments, isolating and purifying the target product hexachlorodisiloxane (HCDSO) from the reacted mixture is completed using standard techniques, including but not limited to filtration of the mixture and distillation of the filtrate. This part has many variations and can easily be reproduced, modified and adapted by any person skillful in art.

These and other aspects of the invention may be understood more readily from the following description.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

Looking at Schemes 1 and 2, reproduced here:

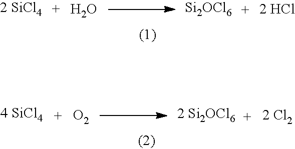

it is easy to see that the starting materials for HCDSO formation include a source for the trichlorosilyl group (SiCl₃) and a source of oxygen. In the two previously described methods, SiCl₄ was used as a source for the trichlorosilyl group while H₂O or O₂ played the latter role as a source of oxygen. While the disclosed process still uses SiCl₄ as a SiCl₃ source, molybdenum trioxide was chosen as an oxygen source. A general scheme for the new method is represented below (Scheme 3):

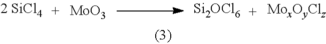

The choice of molybdenum trioxide is primarily dictated both by its 1) ability to provide an oxygen atom to the silicon while also accepting a chlorine atom from SiCl₄, and 2) ease of separation of the forming molybdenum oxochlorides (MoₓO_{y}Cl_{z}) from the mixture containing the product (HCDSO), in the form of an insoluble in such a mixture precipitate.

Two examples of the disclosed method are provided below as “Example 1” and “Example 2.”

### Example 1

A one-liter round bottom 3-neck flask equipped with a magnetic stir bar, 500 mL addition funnel, thermometer well and Torion 8 side-arm tube adapter was charged with anhydrous MoO₃ (101 g, 0.70 mol) under inert atmosphere of nitrogen. SiCl₄ (477 g, 2.80 mol) was added to MoO₃ via the addition funnel at room temperature, and the mixture was stirred using the magnetic stir plate to make a white suspension. A catalytic amount of anhydrous HCl (50 mL of 2M solution in Et₂O, 0.1 mol) was added to this suspension via the addition funnel, and the mixture was stirred at room temperature under inert atmosphere of nitrogen for 30 hours. The resulting yellow-brown mixture was filtered through a medium porosity fritted glass filter to remove brown solid residue from the liquid phase containing HCDSO, as well as ether, excess SiCl₄ and higher perchlorosiloxanes. The majority of low-boiling components of the filtrate were removed under reduced pressure via bulb-to-bulb transfer at room temperature (no heating). The remaining liquid crude product residue (ca. 170 g) contained ˜70% HCDSO (estimated by GC). This crude material was fractionally distilled under 1 atm of nitrogen on a 30 cm Propak packed column using variable take-off distillation head. A HCDSO fraction was collected in 133-134° C. head temperature range, 76 g (38% yield) of the clear colorless liquid product was obtained. The product was over 99% pure (by GC) and over 99.999% in trace metals purity (by ICP-MS).

### Example 2

A one-liter round bottom 3-neck flask equipped with a magnetic stir bar, 500 mL addition funnel, thermometer well and Torion 8 side-arm tube adapter was charged with anhydrous MoO₃ (101 g, 0.70 mol) under inert atmosphere of nitrogen. SiCl₄ (477 g, 2.80 mol) was added to MoO₃ via the addition funnel at room temperature, and the mixture was stirred using the magnetic stir plate to make a white suspension. A catalytic amount of anhydrous HCl (100 mL of 2M solution in Et₂O, 0.2 mol) was added to this suspension via the addition funnel, and the mixture was stirred at room temperature under inert atmosphere of nitrogen for 72 hours. The resulting yellow-brown mixture was filtered through a medium porosity fritted glass filter to remove brown solid residue from the liquid phase containing HCDSO, ether, excess SiCl₄ and higher perchlorosiloxanes, including octachlorotrisiloxane (OCTSO). The majority of low-boiling components of the filtrate, consisting mostly of unreacted SiCl₄ and ether, was removed under reduced pressure via bulb-to-bulb transfer at room temperature (without heating the material). The remaining liquid crude product (211 g) contained 56% HCDSO and 30% OCTSO (estimated by GC). HCDSO (105 g, 52.5% yield) was separated from this mixture by a short-path distillation at 35° C. under full pump vacuum, and OCTSO (38 g, 27% yield) was obtained from the residue by a short-path distillation at 65° C. under full pump vacuum. The isolated OCTSO product was over 95% pure by GC. Further purification of isolated OCTSO by fractional distillation using a variable take-off distillation head and a 1 foot Propak packed column under full pump vacuum afforded product of 99% or better purity by GC and 99.9999% or better trace metals purity by ICP-MS.

While exact amount and ranges of the reaction parameters will vary based on other reaction factors, a preferred yield of product is in the range of about 30-50%, a preferred HCl mol % is in 12-20% range, a preferred temperature range is about 15-25° C. range, and a preferred reaction time is in the 24-36 hour range.

The matter set forth in the foregoing description and any accompanying drawings, appendices, references, or the like is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for producing hexachlorodisiloxane (HCDSO) comprising:
adding an amount of tetrachlorosilane (SiCl₄) to a reaction vessel;
adding an amount of molybdenum trioxide (MoO₃) to the reaction vessel to create a mixture; and
allowing the mixture of tetrachlorosilane and molybdenum trioxide to react together to produce an amount of hexachlorodisiloxane.

2. The method of claim 1, wherein the amount of tetrachlorosilane is a stoichiometric amount based on the reaction 2 SiCl₄+MoO₃→Si₂OCH₆+MoₓO_{y}Cl_{z}.

3. The method of claim 1, wherein the amount of tetrachlorosilane is in excess of a stoichiometric amount based on the reaction 2 SiCl₄+MoO₃→Si₂OCH₆+MoₓO_{y}Cl_{z}.

4. The method of claim 3, wherein a molar ratio of the amount of tetrachlorosilane to the amount of molybdenum trioxide is in the range of from 4:1 to 6:1.

5. The method of claim 3, wherein the amount of tetrachlorosilane is x and falls in the range of 1.0<x≤3.0 the stoichiometric amount.

6. The method of claim 5, wherein x is twice the stoichiometric amount.

7. The method of claim 1, further comprising stirring the mixture in the reaction vessel under an inert atmosphere at ambient temperature for a period of time.

8. The method of claim 7, wherein the inert atmosphere in the reaction vessel is selected from a group of inert gases consisting of nitrogen (N₂), argon (Ar), and helium (He).

9. The method of claim 7, wherein the ambient temperature during stirring of the mixture is in the range of from 10-40° C.

10. The method of claim 7, wherein the period of time for stirring the mixture is in the range of 24-72 hours.

11. The method of claim 5, further comprising:
stirring the mixture in the reaction vessel under an inert atmosphere at ambient temperature for a period of time, wherein the inert atmosphere in the reaction vessel is selected from a group of inert gases consisting of nitrogen (N₂), argon (Ar), and helium (He), the ambient temperature during stirring of the mixture is in the range of from 10-40° C., and the period of time for stirring the mixture is in the range of 24-72 hours.

12. The method of claim 1, further comprising adding a catalytic amount of anhydrous hydrogen chloride (HCl) to the reaction vessel.

13. The method of claim 12, wherein the anhydrous HCl is added as one of either an anhydrous HCl solution in diethyl ether or as anhydrous HCl gas.

14. The method of claim 12, wherein the catalytic amount of anhydrous HCl is in the range of 3-15 molar percent based on the amount of molybdenum trioxide used in the reaction.

15. The method of claim 5, further comprising adding a catalytic amount of anhydrous hydrogen chloride (HCl) to the reaction vessel.

16. The method of claim 15, wherein the catalytic amount of anhydrous HCl is in the range of 3-15 molar percent based on the amount of molybdenum trioxide used in the reaction.

17. The method of claim 1, further comprising:
isolating the amount of hexachlorodisiloxane (HCDSO) from the mixture using standard techniques; and
purifying the amount of hexachlorodisiloxane (HCDSO) using standard techniques.

18. A method for producing perchlorodisiloxane of the general formulae SiₓOₓ₋₁Cl₂ₓ₊₂ comprising:
adding an amount of tetrachlorosilane (SiCl₄) to a reaction vessel;
adding an amount of molybdenum trioxide (MoO₃) to the reaction vessel to create a mixture; and
allowing the mixture of tetrachlorosilane and molybdenum trioxide to react together to produce an amount of a perchlorodisiloxane.

19. The method of claim 18, wherein the perchlorosiloxane is hexachlorodisiloxane (HCDSO).

20. The method of claim 18, wherein the perchlorosiloxane is octochlorotrisiloxane (OCTSO).
